(19) United States
(12) Patent Application Publication
(10) Pub. No.: US 2007/0038314 A1
(43) Pub. Date: Feb. 15, 2007

(54) Motion command reshaping method with analog input for position s curve

(76) Inventor: Tsung-Hsin Cheng, Kaohsiung City (TW)

Correspondence Address: HARNESS, DICKEY & PIERCE, P.L.C., P.O. BOX 8910, RESTON, VA, 20195, US

(21) Appl. No.: 11/238,043

(22) Filed: Sep. 29, 2005

(30) Foreign Application Priority Data
Aug. 10, 2005 (TW) 94127224

(51) Int. Cl. G05B 19/18; G05B 11/32

(52) U.S. Cl. 700/63; 700/69; 700/64

(57) ABSTRACT

A motion command reshaping method with analog input for position s curve is provided to process the motion commands smoothly. In this embodiment, an accumulating and asymmetric architecture and processing of reference points are used to make mathematical calculation with low operation and high resolution, thereby satisfying the required response time during the acceleration/deceleration. Further, the provided method adopts the conception of a motion command reshaping generator with analog input for velocity s curve, thereby applying to various position command reshaping.

### BACKGROUND

1. Field of Invention

The invention relates to a motion command reshaping technology, and more particularly to a motion command reshaping method with analog input for position s curve.

2. Related Art

Due to the differences of friction and load inertia, the servo modules usually need different time settings for acceleration and deceleration during a motion control period; accordingly, the motion command is usually reshaped by a command generator in motion to satisfy the physical properties when operating. Nowadays, the dominant reshaping method for motion command is the way of equation.

Generally speaking, a point-to-point motion is operated by an upper controller or a dedicated controller to reshape the motion command, and then positioned by inputting in the form of pulse wave. However, the required position equation should be deduced through parameters planed previously; therefore a high mathematic operation is still necessary in use. Alternatively, it should be combined with a pulse wave generating device, for example, a digital differential analyzer, to generate a point-to-point positioning pulse wave.

However, in order to obtain the position command, users need to set architecture with dedicated functions, or to utilize high-speed operation units and mathematical calculator of high resolution, to make a high mathematic operation. Otherwise, such a function cannot be realized. In addition, when the position command generator has to be combined with a pulse wave generating device, it indicates that the resolution provided by the position command generator is insufficient. Furthermore, the digital differential analyzer is mainly used for providing output of uniform pulse wave during a time period, thus the users have to construct it with the combination of other hardware to realize this function, such that a zero-error output is obtained. However, in this case, users have to afford the cost of said hardware additionally.

### SUMMARY

In view of the above-mentioned problems, it is the main object of the invention to provide a motion command reshaping method with analog input for position s curve, thereby the problems in the prior art is substantially solved.

The motion command reshaping method with analog input for position s curve disclosed in the present invention adopts an accumulating and asymmetric architecture and processing of reference point to construct various motion command reshaping devices for position s curve.

The motion command reshaping method with analog input for position s curve disclosed in the present invention utilizes architecture of post-acceleration/deceleration, to be applied in the servo driver.

The motion command reshaping method with analog input for position s curve disclosed in the present invention may keep the velocity and the acceleration continual, and have the velocity changed uniformly during acceleration or deceleration.

The motion command reshaping method with analog input for position s curve disclosed in the present invention may avoid the delayed arrival of the motion command when the complete time setting is satisfied.

The motion command reshaping method with analog input for position s curve disclosed in the present invention has a velocity modifying process after completing the acceleration.

Therefore, to achieve the above objects, the motion command reshaping method with analog input for position s curve disclosed in the present invention comprises the steps of: first defining a first position reference point and calculating the basic accumulation of acceleration and deceleration according to the time setting; then checking the state of the internal command, to initialize the state when the acceleration and the velocity is zero; determining the processing program according to the external input command and the moving direction; next performing calculation of acceleration; then performing calculation of velocity according to the calculated acceleration; and thereby generating a motion command for position s curve; finally, going on to carry out state processing.

In which, when the external input command is an increment position command, if it moves in a positive direction, a second position reference point will be recalculated; otherwise, if the increment position command moves in a negative direction, the processing program is set to enter into the third block. When the external input command is an absolute position command, if the external position command and the moving direction are the same, the second position reference point will be recalculated; otherwise, when in the first block, it enters into the second block, while in the second block, into the third block.

Further, if the state of the velocity is acceleration, the calculation of the acceleration will be made through the basic accumulation of acceleration; if the state of the velocity is deceleration, the calculation of the acceleration will be made through the basic accumulation of deceleration; and when in the first block, the operation will be made through the basic accumulation of deceleration to calculate the mirror acceleration of the third block, in the same calculation method with the calculation of the acceleration.

Thus, the calculation method of velocity is the sum of the last velocity command and the acceleration. And the mirror velocity of the third block (i.e. sum of the last mirror velocity and mirror acceleration) is calculated when in the first block.

In addition, the motion command for position s curve is the sum of the last motion command for position s curve and the velocity value. And the mirrored position of the third block (i.e. sum of the last mirrored position and mirror velocity) is calculated when in the first block.

The state process is performed as follows. At first, a velocity command reference point is calculated with reference to a moving velocity or a target velocity, to ensure whether the velocity reaches the velocity command reference point or not. After that, when in the first block, the predetermined position is calculated to see whether it reaches half of the first position command reference point or not, to determine whether the velocity should enter into the end section of the first block symmetrically about the center. Then, when the velocity reaches the velocity command reference point or the predetermined position reaches half of the first position command reference point, the velocity and the acceleration enter into the end section of the first block symmetrically about the center; when the mirrored position reaches the first position command reference point, the second position command reference point is calculated; when the position reaches the second position command reference point, it enters into the third block; and when in the third block, when the velocity reaches half of the moving velocity, the velocity and the acceleration symmetrically enter into the end section of the third block.

The present invention and practice will be described in detail accompanying with the most preferable embodiment.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view illustrating the architecture of the motion command reshaping method of the invention;

FIG. 2 is a flow chart illustrating a motion command reshaping method with analog input for position s curve according to one of the embodiments of the invention;

FIG. 3 is a flow chart illustrating the embodiment in Step 140 of FIG. 2;

FIG. 4 is a flow chart illustrating the embodiment in Step 170 of FIG. 3; and

FIG. 5 shows the simulating result of motion command reshaping device with analog input for velocity s curve applying the motion command reshaping method with analog input for position s curve of the present invention.

### DETAILED DESCRIPTION

First, the main conception of the present invention is illustrated. In the present invention, the calculation of low mathematical operation and high resolution is provided by accumulating operation, to reshape the motion command, thereby satisfying the required response time during acceleration/deceleration. Furthermore, in the present invention, the conception of a motion command reshaping generator for velocity s curve is used for reshaping the position command, to be applied in reshaping any kind of position command, for example the way of inputting command of analog type, pulse wave type or register type.

Hereinafter, specific embodiments will be given to describe the content of the present invention in details, with the assistance of the drawings. The symbols referred in the description are referred to the symbols in the drawings.

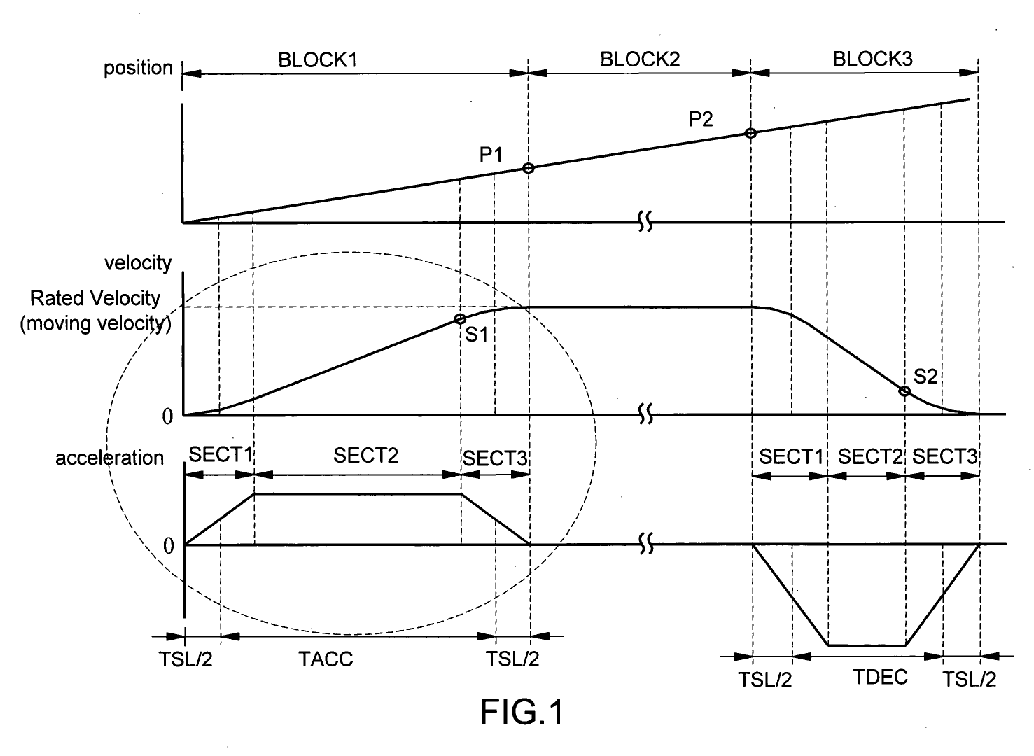

As shown in FIG. 1, the time setting and a command reference point are defined in order to illustrate the architecture of motion command reshaping method, wherein the round dash line portion indicates the architecture of motion command reshaping method for velocity s curve, i.e. the velocity command is reshaped according to the acceleration. TACC shown in the figure is an accelerated time constant; TDEC is a decelerated time constant TSL is a smooth time constant. S1, S2 are the first and the second velocity command reference points respectively; P1, P2 are the first and the second position command reference points respectively. In which, the first velocity command reference point S1 is at the intersection of the intermediate section SECT2 and the end section SECT3 in the first block BLOCK1. The second velocity command reference point S2 is at the intersection of the intermediate sectionSECT2and the end section SECT3 in the third block BLOCK3. The first position command reference point PI is at the intersection of the first block BLOCK1 and the second block BLOCK2; and, the second position command reference point P2 is at the intersection of the second block BLOCK2 and the third block BLOCK3.

According to the principle of the present invention, the accumulating and asymmetric architecture is adopted with the velocity or the position as a reference point, to decide whether the block to be entered has been arrived or not, and the velocity curve and the acceleration curve are set to be symmetric about the center. Therefore, the velocity and the acceleration may be continuous in any state. In other words, the velocity curve in the acceleration block (i.e., the first block BLOCK1) is symmetric about the center, while in the deceleration block (i.e., the third block BLOCK3) is symmetric; and, the acceleration curve in the front and back sections in the acceleration block and the deceleration block (i.e., the initial section SECT1and the end sectionSECT3) is symmetric about the center respectively.

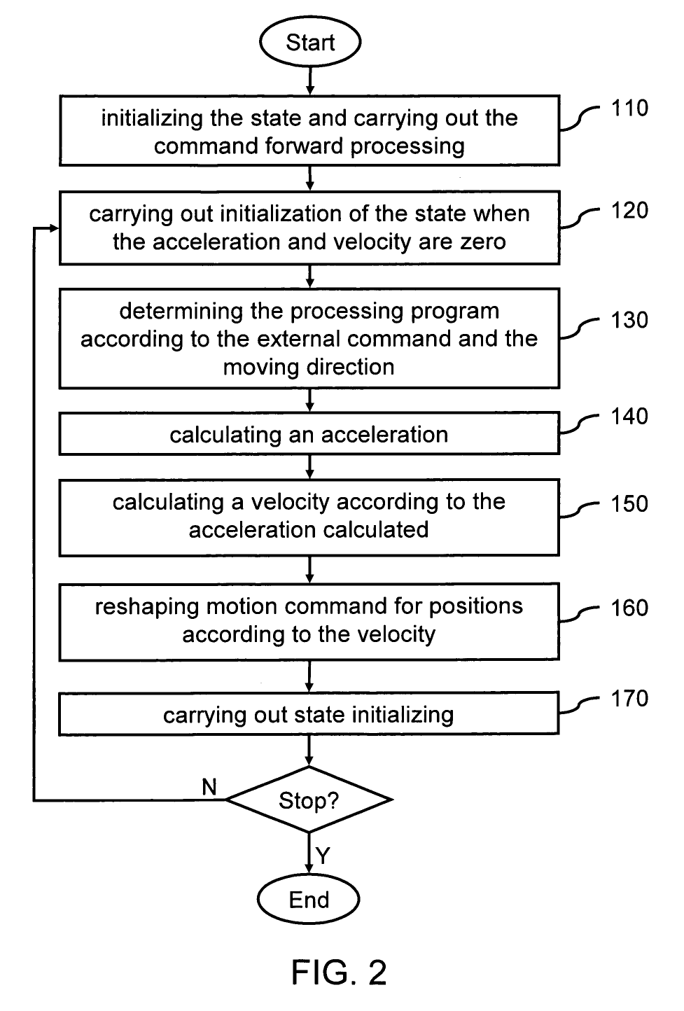

With reference to FIG. 2, a flow chart illustrating a motion command reshaping method with analog input for position s curve according to one of the embodiments of the present invention is shown. First, the state is initialized, i.e. the first position reference point is defined, and the command forward processing is carried out, that is, the accelerated/decelerated basic accumulation is calculated according to the time setting (Step 110). After that, the state of the internal command is checked to carry out initialization when the acceleration and the velocity are zero (Step120). The processing program is determined according to the external input command and the moving direction (Step130). A calculation of the acceleration is made (Step140). Then, a calculation of a velocity is made according to the acceleration calculated (Step150) and thus a motion command for position s curve is reshaped (Step160). Finally, go on to carry out the state processing (Step170).

In fact, Step120 through Step170 are carried out repeatedly before the operation is stopped to keep the reshaping of the motion command for position s curve.

In this embodiment, the acceleration/deceleration is set according to the state of the motor velocity, and the basic accumulation of acceleration is used during acceleration, while the basic accumulation of deceleration is used during deceleration. The basic accumulation of acceleration is (rated velocity/accelerated time constant TACC)/TSL, while the basic accumulation of deceleration is (rated velocity/decelerated time constant TDEC)/TSL.

In Step110, the first position reference point may be set to a quarter of the displacement.

The processing program is determined according to the external input command and the moving direction (Step130). When the external input command is an increment position command, if the increment position command moves in the positive direction, the second position reference point P2 will be recalculated. On the other hand, if the increment position command moves in the negative direction, the processing program will be set to enter into the third block BLOCK3. In addition, when the external input command is an absolute position command, if the external position command and moving direction are the same, the second position reference point P2 will be recalculated. On the other hand, the processing program is decided according to the block it belongs. Namely, when in the first block BLOCK1, the processing program is set to enter into the second block BLOCK2, while in the second block BLOCK2, into the third block BLOCK3.

During the step of the calculation of the acceleration (Step 140), the acceleration is increasing in the initial section SECT1, and is decreasing in the end section SECT3. The section it presents is determined depending on the calculated value. In which, when the calculated value is larger than the smooth time constant TSL, it indicates that the processing program has entered in the intermediate section SECT2; when the velocity command reaches the first velocity command reference point S1, it indicates that the processing program has not entered in the end section SECT3 yet.

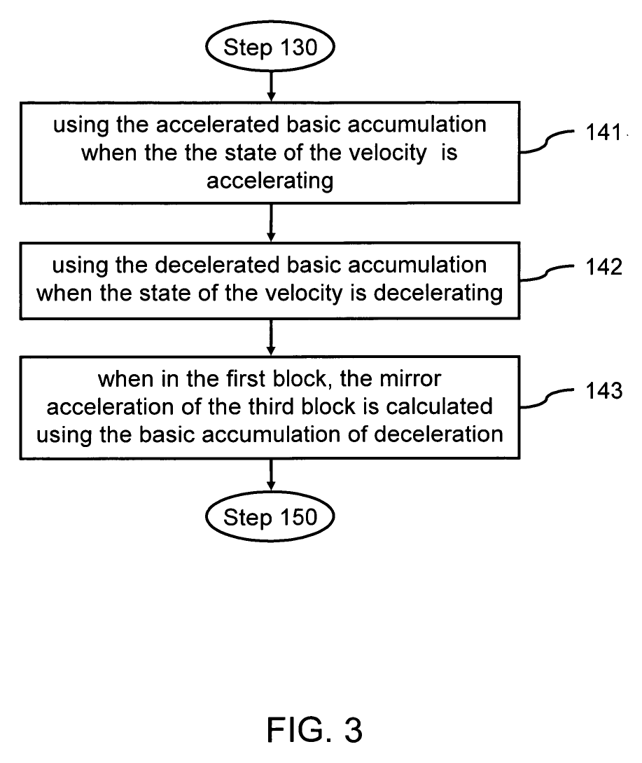

As shown in FIG. 3, the Step 140 may be completed with the following steps. With reference to FIG. 3, when the state of the velocity is accelerating, the accelerated basic accumulation is used (Step 141); when the state of the velocity is decelerating, the decelerated basic accumulation is used (Step 142); and, when in the first block BLOCK1, the decelerated basic accumulation is used to calculate the mirrored acceleration of the third block BLOCK3 with the same calculation method with the calculation of the acceleration (Step 143).

In the step of making the calculation of the velocity according to the acceleration calculated (Step 150), the velocity is the sum of the last velocity command and the acceleration. And when in the first block BLOCK1, the mirrored velocity of the third block BLOCK3, the sum of the last mirror velocity and the mirror acceleration, is calculated.

In which, the step of reshaping motion command for position s curve according to velocity (Step 160) is the sum of the last motion command for position s curve and the velocity value. And when in the first block BLOCK1, the mirrored position of the third block BLOCK3, the sum of the last mirrored position and the mirrored velocity, is calculated.

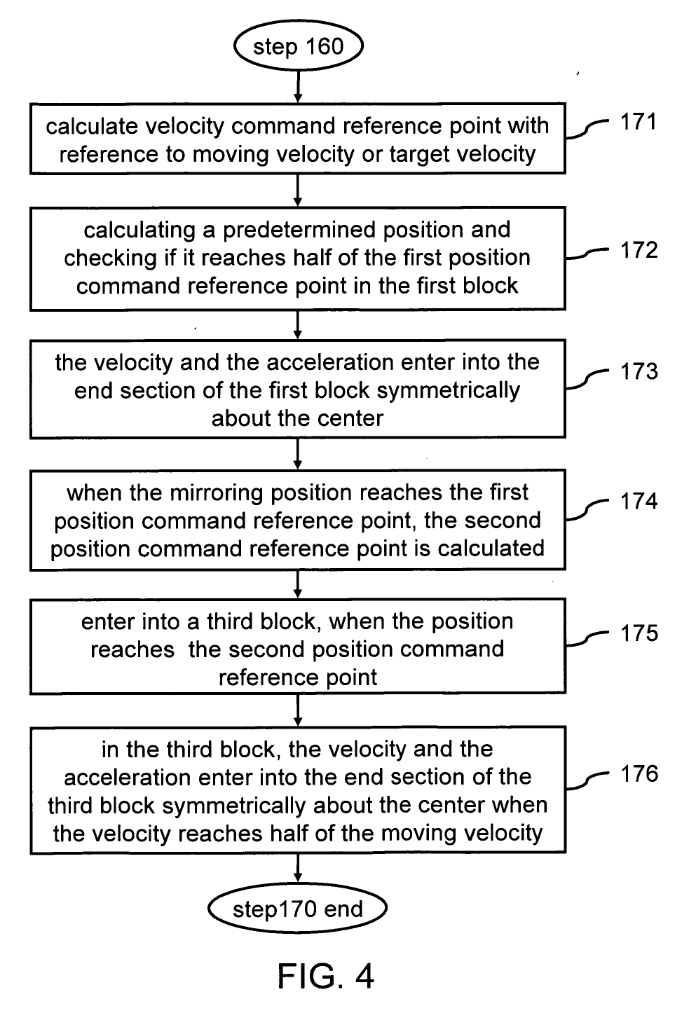

After the motion command for position s curve is reshaped, the state processing is continued (Step 170) in the following steps as shown in FIG. 4.

With reference to FIG. 4, when in the first and the third block BLOCK1, BLOCK3, the first and the second velocity command reference points S1, S2 are calculated referring to the moving velocity (POV) or the target velocity, i.e., to ensure whether the velocity reaches the velocity command reference point or not (Step 171). That is, when in the first block BLOCK1, the velocity is checked to see whether it reaches the first velocity command reference point S1 or not; and when in the third block BLOCK3, the velocity is checked to see whether it reaches the second velocity command reference point S2 or not. That is, the velocity is calculated to see whether it is lager than a predetermined value or not, which is the difference between a target value (i.e. moving velocity) and a relative value. In which, the relative value is half of the product of the acceleration and the count value. The count value is increasing in the initial section SECT1 (i.e., acceleration increasing section), is decreasing in the end section SECT3 (i.e., acceleration decreasing section), and is fixed in the intermediate section SECT2 (i.e., acceleration fixed section). The count value ranges from 0 to TSL.

Then, when in the first block BLOCK1, whether the predetermined position reaches half of the first position command reference point P1 is calculated, to decide whether the velocity should enter into the end section SECT3 of the first block BLOCK1 symmetrically about the center (Step 172). In which, when the accelerated time constant TACC is larger than the decelerated time constant TDEC, the predetermined position is transformed with the mirrored position; on the other hand, when the decelerated time constant TDEC is larger than the accelerated time constant TACC, the predetermined position is transformed with the position command. Namely, when the accelerated time constant TACC is lager than the decelerated time constant TDEC, the mirrored position will be reckoned through the velocity, and the reckoned value is added with the position command, then compared to half of the first position command reference point P1; on the other hand, when the decelerated time constant TDEC is larger than the accelerated time constant TACC, the position command is reckoned through the velocity, and the reckoned value is add with the mirrored position, then compared to half of the first position command reference point P1.

When the state processing meets Step 171 or Step 172, the velocity and the acceleration enter into the end section SECT3 of the first block BLOCK1 symmetrically about the center (Step 173)

When the mirrored position reaches the first position command reference point P1, the second position command reference point P2 is calculated, which is difference between the target value and the first position command reference point P1 (Step 174).

When the position, i.e., the position of the practical movement, reaches the second position command reference point P2, the processing program is entering into the third block BLOCK3 (Step 175).

In the third block BLOCK3, if the velocity reaches half of the moving velocity, the velocity and the acceleration will enter into the end section SECT3 of the third block BLOCK3 symmetrically about the center (Step 176).

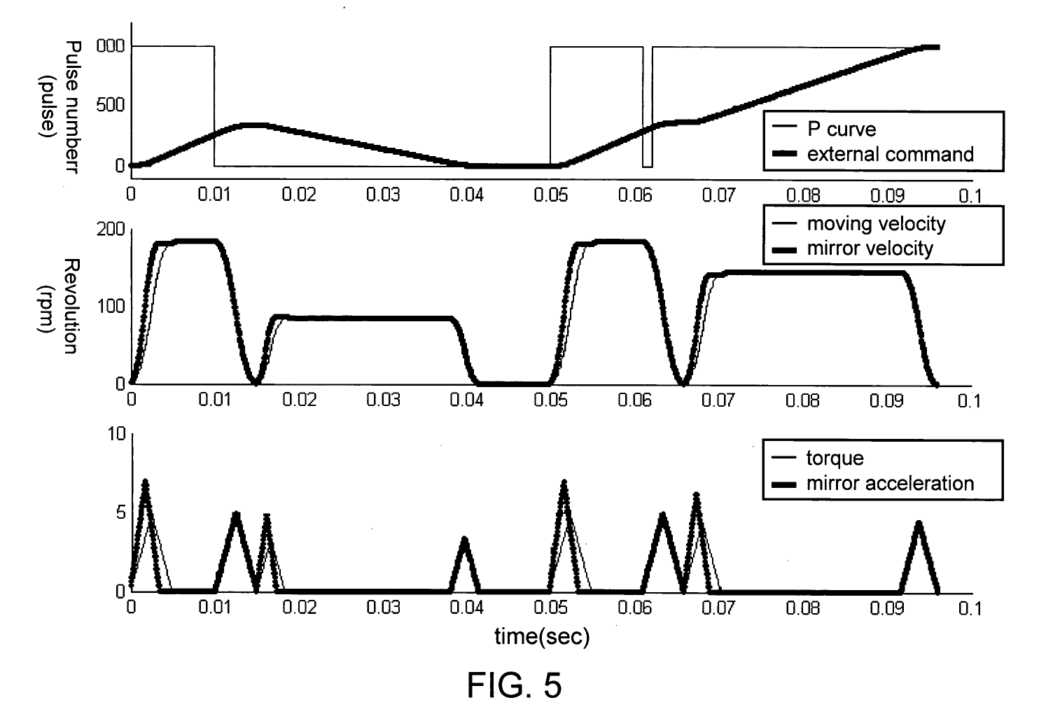

With reference to FIG. 5, a simulation result of the principle of the motion command reshaping device with analog input for position s curve according to the present invention is shown, wherein the bottom drawing shows the change of acceleration; the intermediate drawing stands for the change of velocity, and the top drawing presents the change of position. Comparing with FIG. 1, it can be seen from FIG. 5 that the position of the external command follows the position of the motion command reshaping device for position s curve (i.e. P curve). In which, the figure of mirrored velocity and mirrored acceleration can be seen in the first BLOCK. And when the first BLOCK ends, a process of velocity modifying is experienced, to change the moving velocity into the mirrored velocity, thereby providing a function of avoiding accumulation error.

According to the principle of the present invention, the motion command reshaping method with analog input for position s curve disclosed in the present invention adopts an accumulating and asymmetric architecture and processing of reference point to construct various motion command reshaping devices for velocity s curve; and it utilizes architecture of post-acceleration/deceleration to apply in the servo driver; and it keeps the velocity and the acceleration continual, and have the velocity changed uniformly during acceleration or deceleration. In addition, the motion command reshaping method with analog input for position s curve disclosed in the present invention may avoid the delayed arrival of the motion command when satisfying the time setting. Further, it has a velocity changing process after completing the acceleration.

The present invention is applied in the servo driver to provide a complete and simplified motion command reshaping unit for position s curve, which provides functions comprising: a motion command reshaping device for position s curve with analog input, a motion command reshaping device for position s curve with pulse wave input, a motion command reshaping device for position s curve with absolute input, a motion command reshaping device for s position with increment register, and a fixed-point number calculator of low operation and low bit. The servo driver may offer a complete solution with various command processing modes even without the support of an upper controller.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A motion command reshaping method with analog input for position s curve, comprising the steps of:
calculating an accelerated/decelerated basic accumulation according to a time setting and defining a first position command reference point;
checking an internal command after calculating the accelerated/decelerated basic accumulation, wherein when both of an acceleration and a velocity are zero, initializing a state of the internal command;
determining a processing program according to an input command and a moving direction after checking the internal command;
calculating the acceleration according to the accelerated/decelerated basic accumulation;
calculating the velocity according to the acceleration calculated;
reshaping a motion command for a position s curve according to the velocity calculated; and
carrying out a state processing after achieving the motion command for the position s curve.

2. The motion command reshaping method with analog input for position s curve of claim 1, wherein in the step of calculating an accelerated/decelerated basic accumulation according to a time setting and defining a first position reference point, defining the first position reference point is to set the first position reference point as a quarter of a displacement.

3. The motion command reshaping method with analog input for position s curve of claim 2, wherein when the input command is an absolute type, the step of determining a processing program according to an input command and a moving direction after checking the internal command comprises the steps of:
recalculating a second position command reference point when the position command is the same as the moving direction; and
determining the processing program according to a block belonged when the position command is different from the moving direction, comprising the steps of:
setting the processing program to enter into a second block when the block is in a first block; and
setting the processing program to enter into a third block when the block is in the second block.

4. The motion command reshaping method with analog input for position s curve of claim 2, wherein when the input command is an increment type, the step of determining a processing program according to an input command and a moving direction after checking the internal command comprises the steps of:
recalculating a second position reference point when the moving direction of the position command is a positive direction; and
setting the processing program to enter into a third block when the moving direction of the position command is a negative direction.

5. The motion command reshaping method with analog input for position s curve of claim 1, wherein the step of calculating the acceleration according to the accelerated/decelerated basic accumulation comprises the steps of:
calculating the acceleration using the accelerated basic accumulation during the accelerating;
calculating the acceleration using the decelerated basic accumulation during decelerating; and
using the decelerated basic accumulation to calculate a mirrored acceleration of a third block when in a first block.

6. The motion command reshaping method with analog input for position s curve of claim 1, wherein the step of calculating the velocity according to the acceleration calculated comprises the step of calculating a sum of the last velocity and the acceleration, wherein when in a first block, a mirrored velocity of a third block is calculated.

7. The motion command reshaping method with analog input for position s curve of claim 6, wherein the mirrored velocity of the third block is the sum of the last mirrored velocity and a mirrored acceleration.

8. The motion command reshaping method with analog input for position s curve of claim 1, wherein the step of reshaping a motion command for a position s curve according to the velocity comprises the step of calculating a sum of the last position command and the velocity, wherein when in a first block, a mirrored position of a third block is calculated.

9. The motion command reshaping method with analog input for position s curve of claim 8, wherein the mirrored position of the third block is the sum of the last mirrored position and a mirrored velocity.

10. The motion command reshaping method with analog input for position s curve of claim 1, wherein the step of carrying out a state processing after achieving the motion command for the position s curve comprises the steps of:
calculating a velocity command reference point according to one of a moving velocity a target velocity, and comparing the velocity with the velocity command reference point;
calculating a predetermined position and comparing the predetermined position with the first position command reference point when in a first block;
making the velocity and the acceleration to enter into an end section of the first block symmetrically about a center when one of the velocity reaches the velocity command reference point and the predetermined position reaches half of the first position command reference point is occurred;
calculating a second position command reference point when a mirrored position reaches the first position command reference point;
entering into a third block when the position reaches the second position command reference point; and
comparing the velocity and the moving velocity when in the third block, wherein when the velocity reaches half of the moving velocity, the velocity and the acceleration are made to enter into the end section of the third block symmetrically about the center.

11. The motion command reshaping method with analog input for position s curve of claim 10, wherein the step of calculating a velocity command reference point according to one of a moving velocity a target velocity, and comparing the velocity with the velocity command reference point comprises the steps of:
calculating a first velocity command reference point when in the first block to check whether the velocity reaches the first velocity command reference point; and
calculating a second velocity command reference point when in the third block to check whether the velocity reaches the second velocity command reference point.

12. The motion command reshaping method with analog input for position s curve of claim 10, the step of calculating a velocity command reference point according to one of a moving velocity a target velocity, and comparing the velocity with the velocity command reference point comprises the step of: calculating the velocity and comparing the velocity with a predetermined value.

13. The motion command reshaping method with analog input for position s curve of claim 12, wherein the predetermined value is a difference between a moving velocity and a relative value.

14. The motion command reshaping method with analog input for position s curve of claim 13, wherein the relative value is half of the product of the acceleration and a count value.

15. The motion command reshaping method with analog input for position s curve of claim 14, wherein the count value is increasing in an acceleration increasing section; wherein the count value is decreasing in an acceleration decreasing section; and wherein the count value is fixed in an acceleration fixed section.

16. The motion command reshaping method with analog input for position s curve of claim 15, wherein the count value is increasing when in an initial section; wherein the count value is decreasing in the end section; and wherein the count value is fixed in an intermediate section.

17. The motion command reshaping method with analog input for position s curve of claim 16, wherein the count value ranges from zero to a smooth time constant.

18. The motion command reshaping method with analog input for position s curve of claim 10, the step of calculating a predetermined position and comparing the predetermined position with the first position command reference point when in a first block comprises the steps of:
transforming the predetermined position with the mirrored position when an accelerated time constant is larger than a decelerated time constant;
transforming the predetermined position with the position command when the decelerated time constant is larger than the accelerated time constant; and
comparing the predetermined position with half of the first position command reference point.

19. The motion command reshaping method with analog input for position s curve of claim 18, the step of calculating a predetermined position and comparing the predetermined position with the first position command reference point when in a first block comprises the steps of:
reckoning the mirrored position through the velocity and adding the mirrored position to a position command to obtain the predetermined position when the accelerated time constant is larger than the decelerated time constant;
reckoning the position command through the velocity and adding the position command to the mirrored position to obtain the predetermined position when the decelerated time constant is larger than the accelerated time constant; and
comparing the predetermined position with half of the first position command reference point.

20. The motion command reshaping method with analog input for position s curve of claim 10, wherein the step of calculating a second position command reference point when a mirrored position reaches the first position command reference point comprises the step of: calculating a difference between a target value and the first position command reference point when the mirrored position reaches the first position command reference point.
